(19) United States
(12) Patent Application Publication
(10) Pub. No.: US 2018/0173392 A1
(43) Pub. Date: Jun. 21, 2018

(54) DISPLAY CONTROL DEVICE AND DISPLAY CONTROL METHOD

(71) Applicant: KYOCERA Document Solutions Inc., Osaka (JP)

(72) Inventor: Norie FUJIMOTO, Osaka-shi (JP)

(73) Assignee: KYOCERA Document Solutions Inc., Osaka (JP)

(21) Appl. No.: 15/846,955

(22) Filed: Dec. 19, 2017

(30) Foreign Application Priority Data
Dec. 21, 2016 (JP) 2016-247806

(51) Int. Cl. G06F 3/0485; G06F 3/0488; G06T 3/20

(52) U.S. Cl. CPC G06F 3/0485; G06T 2200/24; G06T 3/20; G06F 3/0488

(57) ABSTRACT

A tablet terminal includes a display, a detecting section, an adjusting section, and a display section. The detecting section detects execution of a tap operation on a first object displayed on the display. The adjusting section adjusts a display location of the first object on the display when the detecting section has detected the execution of the tap operation on the first object. The display section displays a second object exhibiting information related to the first object when the detecting section has detected the execution of the tap operation on the first object.

### INCORPORATION BY REFERENCE

The present application claims priority under 35 U.S.C. § 119 to Japanese Patent Application No. 2016-247806, filed on Dec. 21, 2016. The contents of this application are incorporated herein by reference in their entirety.

### BACKGROUND

The present disclosure relates to a display control device which includes a display, and a display control method.

A certain display location determination apparatus determines whether or not a speech bubble can be displayed in a display area in which no objects are displayed. The speech bubble exhibits information relating to a first object. When it is determined that the speech bubble cannot be displayed in the display area, the display location determination apparatus searches for a second object that has a display occupancy rate of at least a predetermined threshold value. A display area of the speech bubble of the first object is determined within a display area of the second object.

### SUMMARY

A display control device according to an aspect of the present disclosure includes a display, a detecting section, an adjusting section, and a display section. The detecting section detects execution of a predetermined operation on a first object displayed on the display. The adjusting section adjusts a display location of the first object on the display when the detecting section has detected the execution of the predetermined operation on the first object. The display section displays a second object exhibiting information related to the first object when the detecting section has detected the execution of the predetermined operation on the first object.

A display control method according to an aspect of the present disclosure is for implementation by a display control device including a display. The display control method includes detecting, adjusting, and displaying. In the detecting, execution of a predetermined operation on a first object displayed on the display is detected. In the adjusting, a display location of the first object is adjusted on the display when execution of the predetermined operation has been detected on the first object. In the displaying, a second object exhibiting information related to the first object is displayed when the execution of the predetermined operation has been detected on the first object.

### BRIEF DESCRIPTION OF THE DRAWINGS

FIG. 1 is a diagram illustrating a configuration of a tablet terminal according to an embodiment of the present disclosure.

FIG. 2 is a diagram illustrating a configuration of a controller according to the embodiment of the present disclosure.

FIGS. 3A and 3B are diagrams illustrating an example of a process of a detecting section, an adjusting section, and a display section.

FIG. 3A illustrates a first screen before a first object undergoes a tap operation.

FIG. 3B illustrates a second screen after the first object has undergone a tap operation.

FIGS. 4A and 4B are diagrams illustrating another example of the process of the detecting section, the adjusting section, and the display section, different from the example illustrated in FIGS. 3A and 3B.

FIG. 4A illustrates the first screen before the first object undergoes the tap operation.

FIG. 4B illustrates the second screen after the first object has undergone the tap operation.

FIGS. 5A and 5B are diagrams illustrating another example of the process of the detecting section, the adjusting section, and the display section, different from the examples illustrated in FIGS. 3A, 3B, 4A, and 4B.

FIG. 5A illustrates the first screen before the first object undergoes the tap operation.

FIG. 5B illustrates the second screen after the first object has undergone the tap operation.

FIGS. 6A and 6B are diagrams illustrating an example of a display location of the second object relative to the first object.

FIG. 6A illustrates a screen displaying the second object upstream in a second direction relative to the first object.

FIG. 6B illustrates a screen displaying the second object downstream in the second direction relative to the first object.

FIGS. 7A and 7B are diagrams illustrating another example of the display location of the second object relative to the first object, different from the example illustrated in FIGS. 6A and 6B.

FIG. 7A illustrates a screen displaying the second object downstream in a first direction relative to the first object.

FIG. 7B illustrates a screen displaying the second object upstream in the first direction relative to the first object.

FIG. 8 is a flowchart illustrating a process of the controller.

FIG. 9 is a flowchart illustrating a location determination process of the controller.

FIG. 10 is another flowchart illustrating the location determination process of the controller.

### DETAILED DESCRIPTION

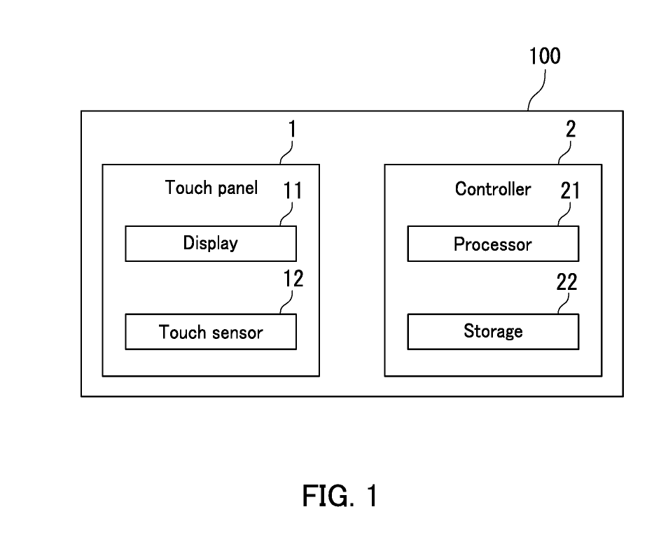

An embodiment of the present disclosure is described as follows with reference to the drawings (FIGS. 1 to 10). Note that elements in the drawings that are the same or equivalent are labelled using the same reference signs and description thereof is not repeated.

First, a configuration of a tablet terminal 100 according to the embodiment of the present disclosure is described with reference to FIG. 1. FIG. 1 is a diagram illustrating the configuration of the tablet terminal 100. As illustrated in FIG. 1, the tablet terminal 100 includes a touch panel 1 and a controller 2. The tablet terminal 100 is an example of a “display control device”. The touch panel 1 displays an image and receives an operation from a user. The controller 2 controls operation of the touch panel 1.

The touch panel 1 includes a display 11 and a touch sensor 12. The display 11 displays an image. The touch sensor 12 detects a touch position of a physical object on the touch panel 1. The touch sensor 12 is located over a display surface of the display 11, for example.

The controller 2 includes a processor 21 and storage 22. The processor 21 includes a central processing unit (CPU), for example. The storage 22 includes memory such as semiconductor memory, and may include a hard disk drive (HDD). The storage 22 stores control programs.

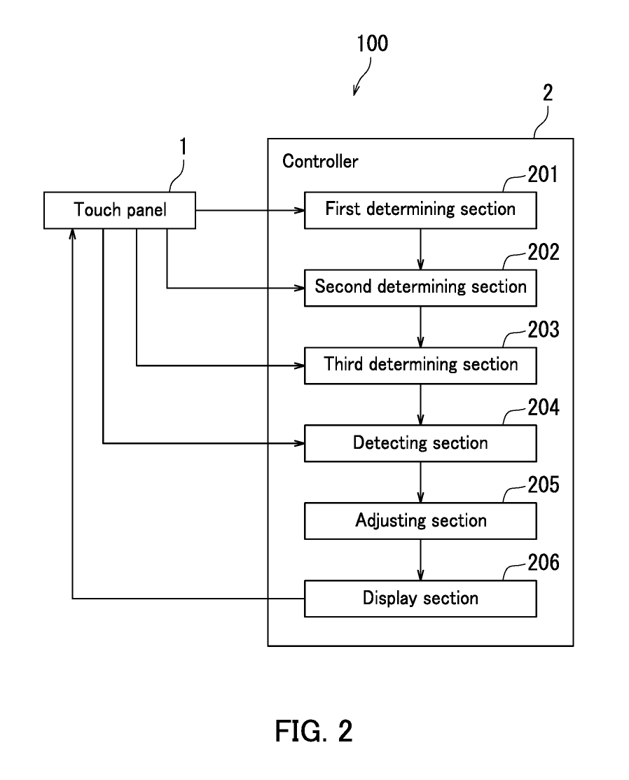

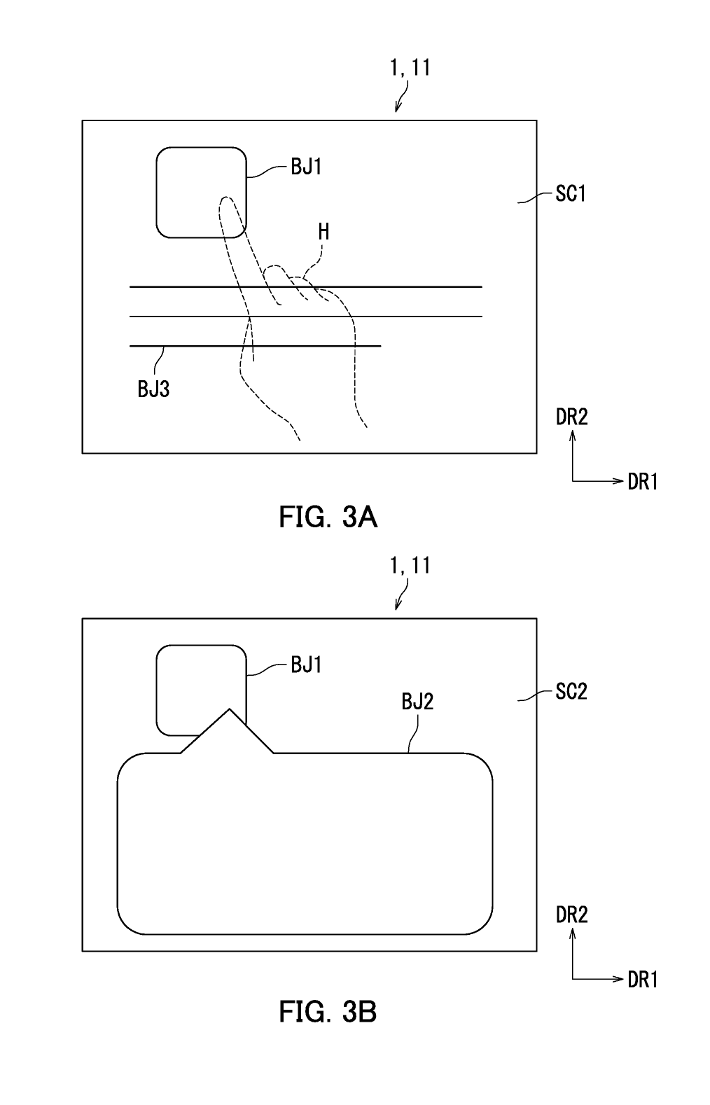

Next, a configuration of the controller 2 according to the embodiment of the present disclosure is described with reference to FIGS. 1 to 3B. FIG. 2 is a diagram illustrating the configuration of the controller 2. FIGS. 3A and 3B are diagrams illustrating an example of a process of the controller 2. FIG. 3A illustrates a first screen SC1 before a first object BJ1 undergoes a tap operation. FIG. 3B illustrates a second screen SC2 after the first object BJ1 has undergone the tap operation. The tap operation is an example of a “predetermined operation”.

As illustrated in FIG. 2, the controller 2 includes a first determining section 201, a second determining section 202, a third determining section 203, a detecting section 204, an adjusting section 205, and a display section 206. Specifically, the processor 21 functions as the first determining section 201, the second determining section 202, the third determining section 203, the detecting section 204, the adjusting section 205, and the display section 206 through the execution of the control programs. The following describes the configuration of the controller 2 illustrated in FIG. 2 with reference to FIGS. 3A and 3B.

The first determining section 201 determines whether the user is right or left-handed.

The second determining section 202 determines whether to display a second object BJ2 downstream or upstream in a first direction DR1 relative to the first object BJ1.

The third determining section 203 determines whether to display the second object BJ2 downstream or upstream in a second direction DR2 relative to the first object BJ1.

The detecting section 204 detects the execution of a predetermined operation on the first object BJ1 displayed in the display 11.

The adjusting section 205 adjusts a display location of the first object BJ1 on the display 11 when the detecting section 204 has detected the execution of the predetermined operation on the first object BJ1.

The display section 206 displays the second object BJ2 exhibiting information related to the first object BJ1 when the detecting section 204 has detected the execution of the predetermined operation on the first object BJ1.

Next, a process of the detecting section 204, the adjusting section 205, and the display section 206 is further described with reference to FIGS. 1 to 3B.

As illustrated in FIG. 3A, the first object BJ1 and a third object BJ3 are displayed on the first screen SC1. The first object BJ1 exhibits an icon, for example. The first object BJ1 is located on the display 11 upstream in the first direction DR1 (on the left side) and downstream in the second direction DR2 (on the upper side). The first direction DR1 refers to a direction parallel to a long side of the display 11. The second direction DR2 refers to a direction parallel to a short side of the display 11. According to the embodiment of the present disclosure, a “direction parallel to a long side” may be referred to as a “long side direction”, and a “direction parallel to a short side” may be referred to as a “short side direction”.

The third object BJ3 exhibits an image of text, for example. The third object BJ3 is located upstream in the second direction DR2 (on the lower side) relative to the first object BJ1.

The detecting section 204 detects the tap operation on the first object BJ1. Specifically, the detecting section 204 detects the tap operation on the first object BJ1 via the touch sensor 12. The “tap operation” refers to an operation in which the user, using a tip of an index finger of a right hand H for example, touches and then releases the touch panel 1 in the location where the first object BJ1 is displayed. The tap operation is also an example of a “touch operation”.

The adjusting section 205 adjusts the display location of the first object BJ1 so as to ensure the area in which the display 11 displays the second object BJ2 when the detecting section 204 has detected the tap operation on the first object BJ1. Specifically, since the first object BJ1 is located on the display 11 downstream in the second direction DR2 (on the upper side), an area exists for displaying the second object BJ2 upstream in the second direction DR2 (on the lower side) relative to the first object BJ1 on the display 11. Therefore, the adjusting section 205 determines that the first object BJ1 is displayed in an appropriate location. In a situation like this, the adjusting section 205 need not adjust the display location of the first object BJ1.

The display section 206 displays the second object BJ2 illustrated in FIG. 3B on the display 11 when the detecting section 204 has detected the tap operation on the first object BJ1.

As illustrated in FIG. 3B, the first object BJ1 and the second object BJ2 are displayed on the display 11. The second object BJ2 is located upstream in the second direction DR2 (on the lower side) relative to the first object BJ1. The third object BJ3 is hidden by the second object BJ2.

The second object BJ2 exhibits information related to the first object BJ1. Specifically, the second object BJ2 exhibits a description of a function of the first object BJ1, for example. Also, the second object BJ2 exhibits a so-called “speech bubble”.

As described above with reference to FIGS. 1 to 3B, according to the embodiment of the present disclosure, the adjusting section 205 adjusts the display location of the first object BJ1 on the display 11, and the display section 206 displays the second object BJ2 exhibiting information related to the first object BJ1 when the detecting section 204 has detected the execution of the predetermined operation on the first object BJ1. Therefore, the second object BJ2 can be displayed on the display 11 without adjusting a size or a shape of the second object BJ2 by adjusting the location of the first object BJ1 to an appropriate location. As a result, the second object BJ2 can be displayed so as to be easily viewed by the user.

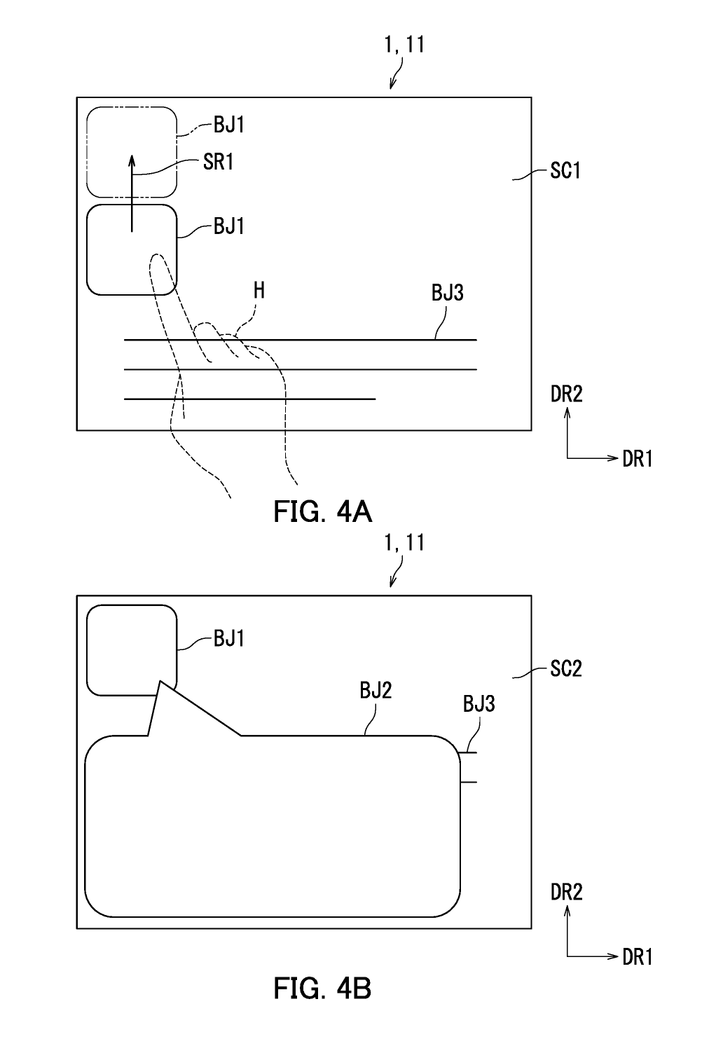

Next, the process of the detecting section 204, the adjusting section 205, and the display section 206 is further described with reference to FIGS. 1 to 5B. FIGS. 4A and 4B are diagrams illustrating another example of the process of the detecting section 204, the adjusting section 205, and the display section 206, different from the example illustrated in FIGS. 3A and 3B. FIG. 4A illustrates the first screen SC1. FIG. 4B illustrates the second screen SC2. In FIGS. 4A and 4B, the location of the first object BJ1 on the first screen SC1 differs from the location illustrated in FIGS. 3A and 3B. Specifically, the first object BJ1 in FIG. 4A is located in an approximate middle of the display 11 with respect to the second direction DR2, whereas the first object BJ1 in FIG. 3A is located downstream in the second direction DR2 (on the upper side) on the display 11. In the following description, main points of difference between FIGS. 3A and 3B and FIGS. 4A and 4B are described.

As illustrated in FIG. 4A, the first object BJ1 and the third object BJ3 are displayed on the first screen SC1. The first object BJ1 is located downstream in the first direction DR1 (on the left side) and in the approximate middle with respect to the second direction DR2, on the first screen SC1.

The detecting section 204 detects the tap operation on the first object BJ1.

The adjusting section 205 adjusts the display location of the first object BJ1 on the display 11 so as to ensure the area in which the display 11 displays the second object BJ2 when the detecting section 204 has detected the tap operation on the first object BJ1. Specifically, the adjusting section 205 scrolls the first screen SC1 downstream in the second direction DR2, in a direction indicated by an arrow SR1, so that the first object BJ1 is located downstream in the second direction DR2 (on the upper side) on the display 11.

As illustrated in FIG. 4B, this results in the first object BJ1 being located downstream in the second direction DR2 (on the upper side) on the display 11. Therefore, an area for displaying the second object BJ2 upstream in the second direction DR2 (on the lower side) relative to the first object BJ1 on the display 11 is ensured.

The display section 206 displays the second object BJ2 as illustrated in FIG. 4B on the display 11 when the detecting section 204 has detected the tap operation on the first object BJ1. The third object BJ3 is partially hidden by the second object BJ2.

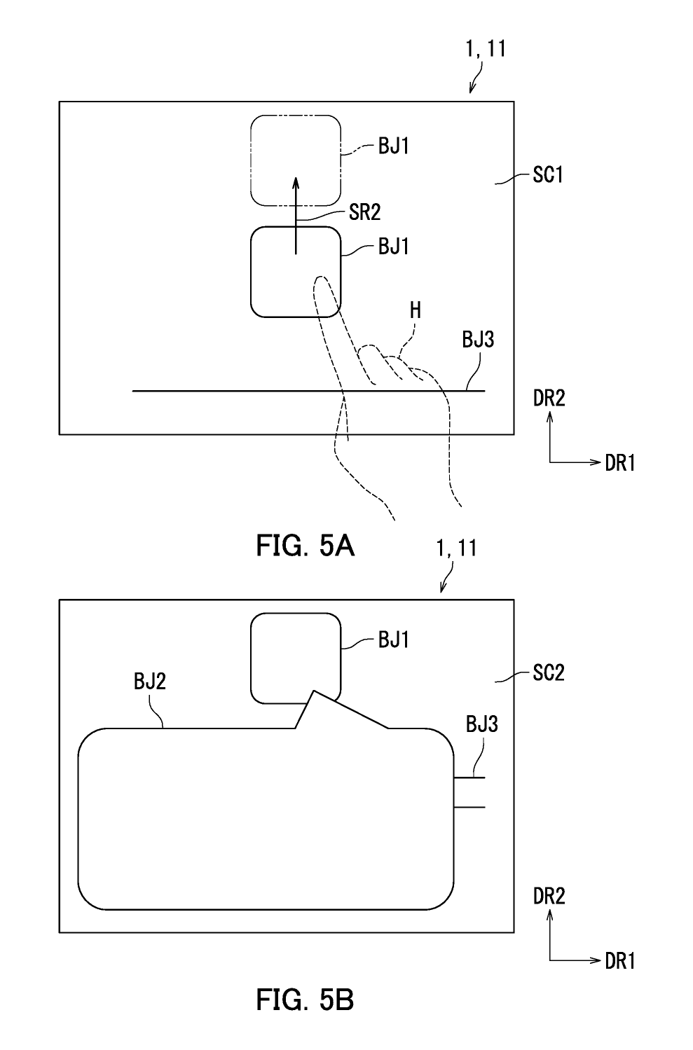

FIGS. 5A and 5B are diagrams illustrating another example of the process of the detecting section 204, the adjusting section 205, and the display section 206, different from the examples illustrated in FIGS. 3A to 4B. FIG. 5A illustrates the first screen SC1. FIG. 5B illustrates the second screen SC2. In FIGS. 5A and 5B, the location of the first object BJ1 on the first screen SC1 differs from the locations illustrated in FIGS. 3A to 4B.

Specifically, the first object BJ1 in FIG. 5A is located in the approximate middle of the display 11 with respect to the second direction DR2, whereas the first object BJ1 in FIG. 3A is located downstream in the second direction DR2 (on the upper side) on the display 11. Also, the first object BJ1 in FIG. 5A is located in the approximate middle of the display 11 with respect to the first direction DR1, whereas the first object BJ1 in FIG. 3A is located upstream in the first direction DR1 (on the left side) on the display 11.

Also, the first object BJ1 in FIG. 5A is located in the approximate middle of the display 11 with respect to the first direction DR1, whereas the first object BJ1 in FIG. 4A is located upstream in the first direction DR1 (on the left side) on the display 11. In the following description, main points of difference between FIGS. 3A and 3B and FIGS. 5A and 5B are described.

As illustrated in FIG. 5A, the first object BJ1 and the third object BJ3 are displayed on the first screen SC1. The first object BJ1 is located in an approximate center of the first screen SC1 with respect to the first and second directions DR1 and DR2.

The detecting section 204 detects the tap operation on the first object BJ1.

The adjusting section 205 scrolls the first screen SC1 downstream in the second direction DR2, in a direction indicated by an arrow SR2, so that the first object BJ1 is located downstream in the second direction DR2 (on the upper side) on the display 11 when the detecting section 204 has detected the tap operation on the first object BJ1.

As illustrated in FIG. 5B, this results in the first object BJ1 being located downstream in the second direction DR2 (on the upper side) on the display 11. Therefore, the area for displaying the second object BJ2 upstream in the second direction DR2 (on the lower side) relative to the first object BJ1 on the display 11 is ensured.

The display section 206 displays the second object BJ2 illustrated in FIG. 5B on the display 11 when the detecting section 204 has detected the tap operation on the first object BJ1. The third object BJ3 is partially hidden by the second object BJ2.

As described above with reference to FIGS. 1 to 5B, according to the embodiment of the present disclosure, the display section 206 displays the second object BJ2 on the display 11 when the tap operation has been executed on the first object BJ1. Therefore, the user can display the second object BJ2 on the display 11 with a simple operation.

Also, the adjusting section 205 adjusts the display location of the first object BJ1 on the display 11 by scrolling the first screen SC1. Therefore, the second object BJ2 can be displayed on the display 11 without changing a layout of the first screen SC1.

Furthermore, the adjusting section 205 adjusts the display location of the first object BJ1 on the display 11 so as to ensure the area in which the second object BJ2 can be displayed on the display 11. Accordingly, the area in which the second object BJ2 is displayed on the display 11 can be ensured by adjusting the display location of the first object BJ1 on the display 11. Therefore, the second object BJ2 can be displayed on the display 11 without adjusting the size or the shape of the second object BJ2.

As described above with reference to FIGS. 1 to 5B, the display section 206 displays the second object BJ2 upstream in the second direction DR2 (on the lower side) relative to the first object BJ1, but the present disclosure is not limited hereto. As long as the second object BJ2 is displayed, the display section 206 may display the second object BJ2 upstream or downstream in the second direction DR2 (on the lower or upper side) relative to the first object BJ1, or upstream or downstream in the first direction DR1 (on the left or right side) relative to the first object BJ1.

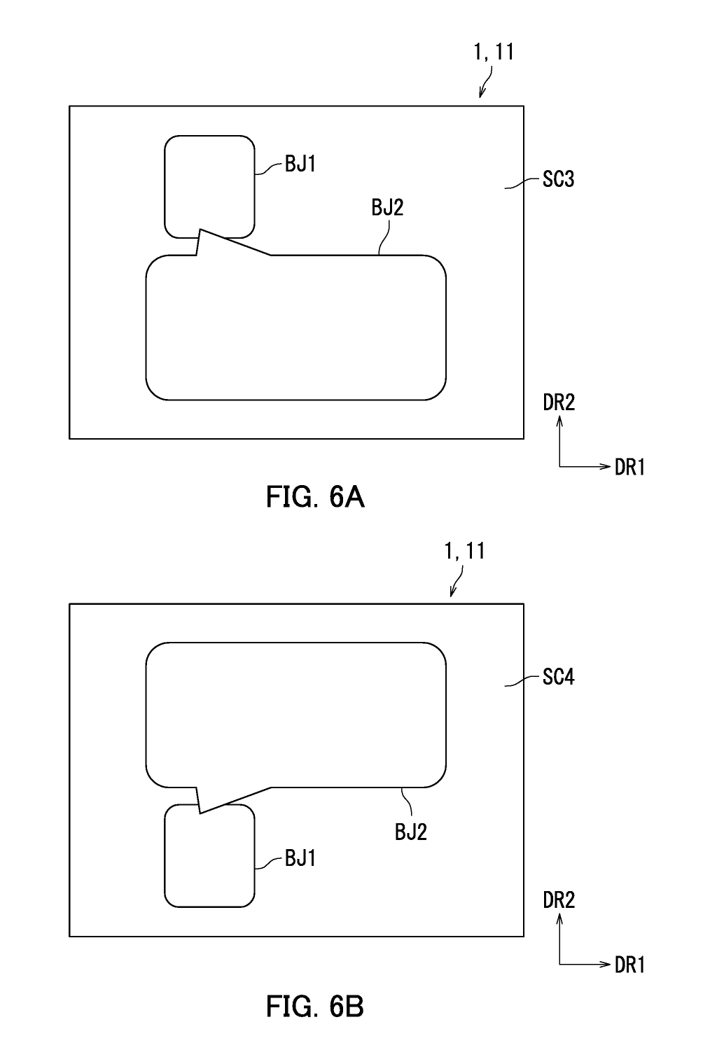

Next, the display location of the second object BJ2 relative to the first object BJ1 is described with reference to FIGS. 1 to 7B. FIGS. 6A and 6B are diagrams illustrating an example of the display location of the second object BJ2 relative to the first object BJ1. FIG. 6A illustrates a screen SC3 displaying the second object BJ2 upstream in the second direction DR2 relative to the first object BJ1. FIG. 6B illustrates a screen SC4 displaying the second object BJ2 downstream in the second direction DR2 relative to the first object BJ1.

In the screen SC3 illustrated in FIG. 6A, the display section 206 displays the second object BJ2 upstream in the second direction DR2 (on the lower side) relative to the first object BJ1. In this situation, the adjusting section 205 scrolls the screen SC3 downstream in the second direction DR2 (in an upper direction) so that the first object BJ1 is located downstream in the second direction DR2 (on the upper side) on the display 11.

In the screen SC4 illustrated in FIG. 6B, the display section 206 displays the second object BJ2 downstream in the second direction DR2 (on the upper side) relative to the first object BJ1. In this situation, the adjusting section 205 scrolls the screen SC4 upstream in the second direction DR2 (in a lower direction) so that the first object BJ1 is located upstream in the second direction DR2 (on the lower side) on the display 11.

The third determining section 203 determines whether to display the second object BJ2 downstream or upstream in the second direction DR2 relative to the first object BJ1. That is, when the third determining section 203 has determined to display the second object BJ2 downstream in the second direction DR2 relative to the first object BJ1, the display section 206 displays the screen SC4 as illustrated in FIG. 6B. Also, when the third determining section 203 has determined to display the second object BJ2 upstream in the second direction DR2 relative to the first object BJ1, the display section 206 displays the screen SC3 as illustrated in FIG. 6A.

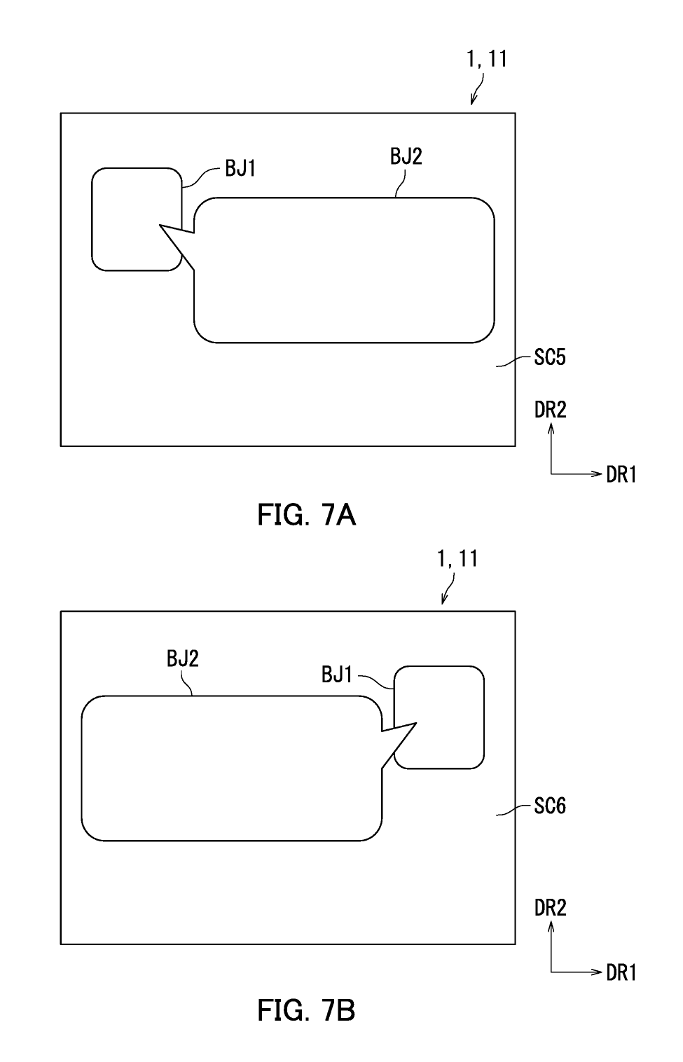

FIGS. 7A and 7B are diagrams illustrating another example of the display location of the second object BJ2 relative to the first object BJ1, different from the example illustrated in FIGS. 6A and 6B. The example illustrated in FIGS. 6A and 6B and the example illustrated in FIGS. 7A and 7B differ in the following point: FIGS. 6A and 6B illustrate the display locations of the first and second objects BJ1 and BJ2 with respect to the first direction DR1, and FIGS. 7A and 7B illustrate the display locations of the first and second objects BJ1 and BJ2 with respect to the second direction DR2. FIG. 7A illustrates a screen SC5 displaying the second object BJ2 downstream in the first direction DR1 relative to the first object BJ1. FIG. 7B illustrates a screen SC6 displaying the second object BJ2 upstream in the first direction DR1 relative to the first object BJ1.

In the screen SC5 illustrated in FIG. 7A, the display section 206 displays the second object BJ2 downstream in the first direction DR1 (on the right side) relative to the first object BJ1. In this situation, the adjusting section 205 scrolls the screen SC5 upstream in the first direction DR1 (in a left direction) so that the first object BJ1 is located upstream in the first direction DR1 (on the left side) on the display 11.

In the screen SC6 illustrated in FIG. 7B, the display section 206 displays the second object BJ2 upstream in the first direction DR1 (on the left side) relative to the first object BJ1. In this situation, the adjusting section 205 scrolls the screen SC6 downstream in the first direction DR1 (in a right direction) so that the first object BJ1 is located downstream in the first direction DR1 (on the right side) on the display 11.

The second determining section 202 determines whether to display the second object BJ2 downstream or upstream in the first direction DR1 relative to the first object BJ1. That is, when the second determining section 202 has determined to display the second object BJ2 downstream in the first direction DR1 relative to the first object BJ1, the display section 206 displays the screen SC5 as illustrated in FIG. 7A. Also, when the second determining section 202 has determined to display the second object BJ2 upstream in the first direction DR1 relative to the first object BJ1, the display section 206 displays the screen SC6 as illustrated in FIG. 7B.

As described above with reference to FIGS. 1 to 7B, according to the embodiment of the present disclosure, the second determining section 202 determines whether to display the second object BJ2 downstream or upstream in the first direction DR1 relative to the first object BJ1. The adjusting section 205 then adjusts the display location of the first object BJ1 on the display 11 depending on the determination result of the second determining section 202. Therefore, the second object BJ2 can be displayed in a location desired by the user on the display 11 with respect to the first direction DR1.

Also, the second determining section 202 determines whether to display the second object BJ2 downstream or upstream in the second direction DR2 relative to the first object BJ1. The adjusting section 205 then adjusts the display location of the first object BJ1 on the display 11 depending on the determination result of the second determining section 202. Therefore, the second object BJ2 can be displayed on the display 11 in a location desired by the user with respect to the second direction DR2.

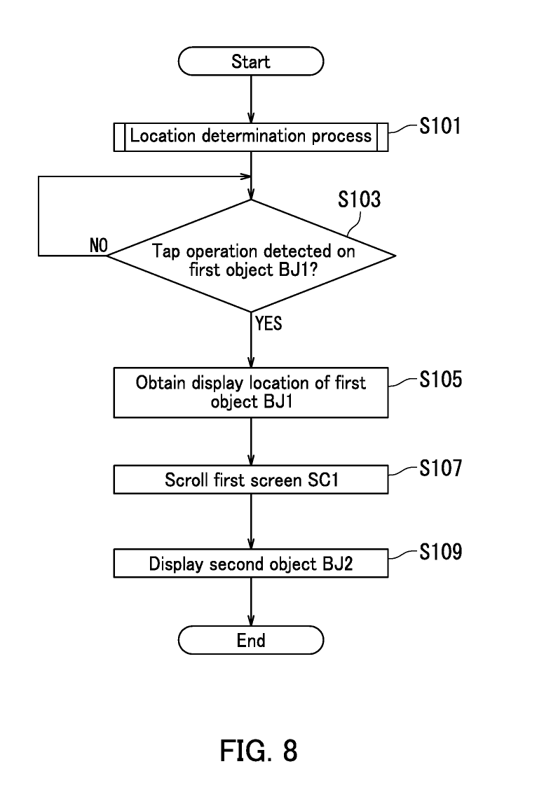

Next, a process of the controller 2 is described with reference to FIGS. 1 to 5B and 8. FIG. 8 is a flowchart illustrating the process of the controller 2.

As illustrated in FIG. 8, the controller 2 first executes a “location determination process” in Step S101. The location determination process means a process of determining the location in which the second object BJ2 is displayed relative to the first object BJ1.

Next, the detecting section 204 determines whether or not the tap operation on the first object BJ1 has been detected in Step S103.

When the detecting section 204 has determined that the tap operation on the first object BJ1 is not detected (NO in Step S103), the process goes into a standby state. When the detecting section 204 has determined that the tap operation on the first object BJ1 has been detected (YES in Step S103), the process progresses to Step S105.

The adjusting section 205 then obtains the display location of the first object BJ1 on the display 11 in Step S105.

Next, the adjusting section 205 adjusts the display location of the first object BJ1 in Step S107. Specifically, the adjusting section 205 adjusts the display location of the first object BJ1 on the display 11 so as to ensure the area in which the second object BJ2 can be displayed on the display 11. More specifically, the adjusting section 205 scrolls the first screen SC1 displayed on the display 11 so as to ensure the area in which the second object BJ2 can be displayed on the display 11.

The display section 206 then displays the second object BJ2 on the display 11 in Step S109, and the process ends.

As described above with reference to FIGS. 1 to 5B and 8, according to the embodiment of the present disclosure, the display location of the first object BJ1 is adjusted and the second object BJ2 is displayed on the display 11 when the execution of the tap operation on the first object BJ1 has been detected. Therefore, the second object BJ2 can be displayed on the display 11 without adjusting the size or the shape of the second object BJ2 by adjusting the location of the first object BJ1 to an appropriate location. As a result, the second object BJ2 can be displayed so as to be easily viewed by the user.

Note that Step S103 is equivalent to “detecting”, Steps S105 and S107 are equivalent to “adjusting”, and Step S109 is equivalent to “displaying”.

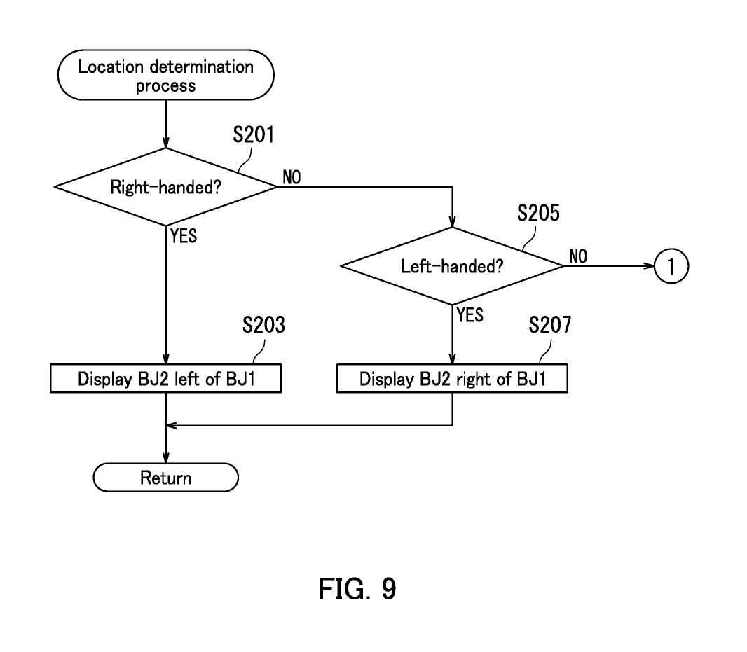

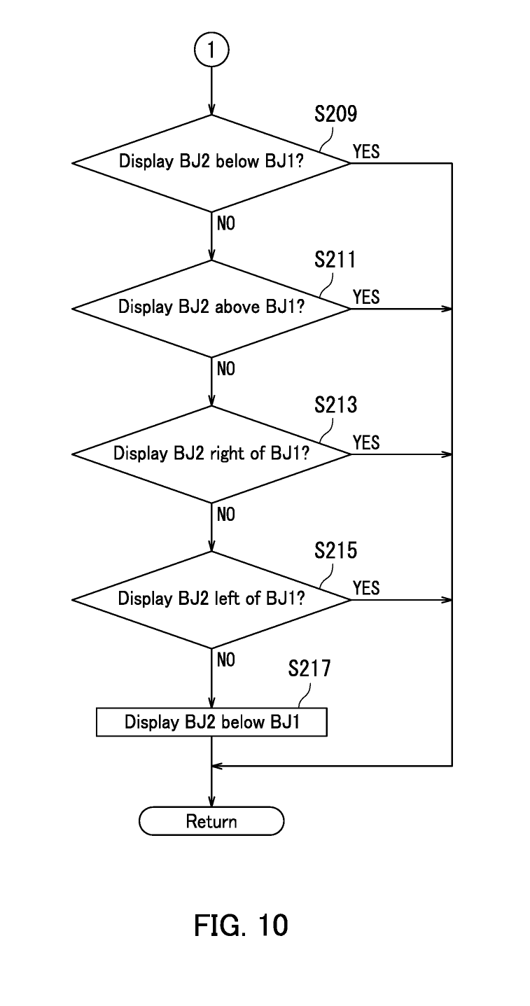

Next, the location determination process of the controller 2 is described with reference to FIGS. 1, 2, 6A to 9, and 10. FIGS. 9 and 10 are a flowchart illustrating the location determination process of the controller 2.

As illustrated in FIG. 9, the first determining section 201 first determines whether or not the user is right-handed in Step S201. For example, the first determining section 201 determines whether or not the user is right-handed based on an operation of the user through the touch panel 1. Specifically, the first determining section 201 displays two buttons on the touch panel 1: a right-handed button to be touched to select right-handedness and a left-handed button to be touched to select left-handedness. The first determining section 201 then determines that the user is right-handed when a touch of the right-handed button is detected, or that the user is left handed when a touch of the left-handed button is detected.

When the first determining section 201 has determined that the user is not right-handed (NO in Step S201), the process progresses to Step S205. When the first determining section 201 has determined that the user is right-handed (YES in Step S201), the process progresses to Step S203.

The first determining section 201 then determines to display the second object BJ2 upstream in the first direction DR1 (on the left side) relative to the first object BJ1 in Step S203, and the process returns to Step S103 in FIG. 8.

When NO in Step S201, the first determining section 201 determines whether or not the user is left-handed in Step S205. For example, the first determining section 201 determines whether or not the user is left-handed based on an operation of the user through the touch panel 1.

When the first determining section 201 has determined that the user is not left-handed (NO in Step S205), the process progresses to Step S209 in FIG. 10. When the first determining section 201 has determined that the user is left-handed (YES in Step S205), the process progresses to Step S207.

The first determining section 201 then determines to display the second object BJ2 downstream in the first direction DR1 (on the right side) relative to the first object BJ1 in Step S207, and the process returns to Step S103 in FIG. 8.

When NO in Step S205, the third determining section 203 determines whether or not to display the second object BJ2 upstream in the second direction DR2 (on the lower side) relative to the first object BJ1 in Step S209 as illustrated in FIG. 10. For example, the third determining section 203 determines whether or not to display the second object BJ2 upstream in the second direction DR2 relative to the first object BJ1 based on the operation of the user through the touch panel 1. Specifically, the third determining section 203 displays a down button that is touched when the second object BJ2 is to be displayed upstream in the second direction DR2. The third determining section 203 then determines to display the second object BJ2 upstream in the second direction when a touch of the down button is detected.

When the third determining section 203 has determined to display the second object BJ2 upstream in the second direction DR2 relative to the first object BJ1 (YES in Step S209), the process returns to Step S103 in FIG. 8. When the third determining section 203 has determined not to display the second object BJ2 upstream in the second direction DR2 relative to the first object BJ1 (NO in Step S209), the process progresses to Step S211.

The third determining section 203 then determines whether or not to display the second object BJ2 downstream in the second direction DR2 (on the upper side) relative to the first object BJ1 in Step S211. For example, the third determining section 203 determines whether or not to display the second object BJ2 downstream in the second direction DR2 (on the upper side) relative to the first object BJ1 based on the operation of the user through the touch panel 1. Specifically, the third determining section 203 displays an up button that is touched when the second object BJ2 is to be displayed downstream in the second direction DR2. The third determining section 203 then determines to display the second object BJ2 downstream in the second direction DR2 when a touch of the up button is detected.

When the third determining section 203 has determined to display the second object BJ2 downstream in the second direction DR2 relative to the first object BJ1 (YES in Step S211), the process returns to Step S103 in FIG. 8. When the third determining section 203 has determined not to display the second object BJ2 downstream in the second direction DR2 relative to the first object BJ1 (NO in Step S211), the process progresses to Step S213.

The second determining section 202 then determines whether or not to display the second object BJ2 downstream in the first direction DR1 (on the right side) relative to the first object BJ1 in Step S213. For example, the second determining section 202 determines whether or not to display the second object BJ2 downstream in the first direction DR1 (on the right side) relative to the first object BJ1 based on the operation of the user through the touch panel 1. Specifically, the third determining section 203 displays a right button that is touched when the second object BJ2 is to be displayed downstream in the first direction DR1. The third determining section 203 then determines to display the second object BJ2 downstream in the first direction DR1 when a touch of the right button is detected.

When the second determining section 202 has determined to display the second object BJ2 downstream in the first direction DR1 relative to the first object BJ1 (YES in Step S213), the process returns to Step S103 in FIG. 8. When the second determining section 202 has determined not to display the second object BJ2 downstream in the first direction DR1 relative to the first object BJ1 (NO in Step S213), the process progresses to Step S215.

The third determining section 203 then determines whether or not to display the second object BJ2 upstream in the first direction DR1 (on the left side) relative to the first object BJ1 in Step S215. For example, the third determining section 203 determines whether or not to display the second object BJ2 upstream in the first direction DR1 relative to the first object BJ1 based on the operation of the user through the touch panel 1. Specifically, the third determining section 203 displays a left button that is touched when the second object BJ2 is to be displayed upstream in the first direction DR1. The third determining section 203 then determines to display the second object BJ2 upstream in the first direction DR1 when a touch of the left button is detected.

When the third determining section 203 has determined to display the second object BJ2 upstream in the first direction DR1 relative to the first object BJ1 (YES in Step S215), the process returns to Step S103 in FIG. 8. When the third determining section 203 has determined not to display the second object BJ2 upstream in the first direction DR1 relative to the first object BJ1 (NO in Step S215), the process progresses to Step S217.

The controller 2 then determines to display the second object BJ2 upstream in the second direction DR2 (on the lower side) relative to the first object BJ1 in Step S217, and the process returns to Step S103 in FIG. 8.

As described above with reference to FIGS. 1, 2, 6A to 9, and 10, according to the embodiment of the present disclosure, the display location of the first object BJ1 on the display 11 is adjusted depending on whether the user is right-handed or left-handed. Specifically, the second object BJ2 is displayed to the left of the first object BJ1 when the user is right-handed. In this situation, the adjusting section 205 scrolls the first screen SC1 so that the first object BJ1 is located on the right side of the display 11. By contrast, the second object BJ2 is displayed to the right of the first object BJ1 when the user is left-handed. In this situation, the adjusting section 205 scrolls the first screen SC1 so that the first object BJ1 is located on the left side of the display 11. Therefore, the second object BJ2 can be displayed in a more suitable position. For example, the second object BJ2 can be inhibited from being hidden by the hand of the user when performing the tap operation on the first object BJ1.

The embodiment of the present disclosure is described above with reference to the drawings. However, the present disclosure is not limited to the above-described embodiment and can be practiced in various ways within the scope not departing from the gist of the present disclosure (as described below in (1) to (6), for example). The drawings schematically illustrate elements of configuration in order to facilitate understanding, and properties of elements of configuration illustrated in the drawings, such as thicknesses, lengths, and numbers thereof, may differ from actual properties thereof in order to facilitate preparation of the drawings. Furthermore, properties of elements of configuration described in the above embodiment, such as shapes and dimensions, are merely examples and are not intended as specific limitations and may be altered in various ways within the scope not departing from the gist thereof.

(1) As described with reference to FIG. 1, according to the embodiment of the present disclosure, the “display control device” is the tablet terminal 100. However, the present disclosure is not limited hereto. The display control device is only required to include the display 11 and the controller 2. According to another embodiment, for example, the display control device may be an apparatus such as a smartphone, a CD player, a DVD player, or other various household electrical appliances. According to another embodiment, the display control device may be a car navigation system, for example. According to another embodiment, the display control device may be a personal computer, for example.

(2) As described with reference to FIGS. 1 to 10, according to the embodiment of the present disclosure, the first object BJ1 exhibits an icon. However, the present disclosure is not limited hereto. The first object BJ1 is only required to be something displayed on the display 11. According to another embodiment, for example, the first object may be a button object or an image object.

(3) As described with reference to FIGS. 1 to 10, according to the embodiment of the present disclosure, the second object BJ2 exhibits a speech bubble. However, the present disclosure is not limited thereto. The second object is only required to exhibit information related to the first object. According to another embodiment, for example, the second object may be a button object or an image object.

(4) As described with reference to FIGS. 1 to 5B and 8, according to the embodiment of the present disclosure, the “predetermined operation” is the tap operation. However, the present disclosure is not limited hereto. The predetermined operation is only required to be an operation on the first object. According to another embodiment, for example, the predetermined operation may be a double tap operation on the first object. According to another embodiment, the predetermined operation may be a swipe operation on the first object, for example. According to another embodiment, the predetermined operation may be a left-click operation of a mouse, for example.

(5) As described with reference to FIGS. 1 to 5B and 8, according to the embodiment of the present disclosure, the adjusting section 205 scrolls the first screen SC1. However, the present disclosure is not limited hereto. The adjusting section 205 is only required to move the first screen SC1. According to another embodiment, for example, the adjusting section 205 may switch the first screen SC1 to the second screen SC2.

(6) As described with reference to FIGS. 1 to 10, according to the embodiment of the present disclosure, the display section 206 displays the second object BJ2 after the adjusting section 205 has adjusted the display location of the first object BJ1 on the display 11 However, the present disclosure is not limited hereto. The adjusting section 205 is only required to adjust the display location of the first object BJ1, and the display section 206 is only required to display the second object BJ2 on the display 11, when the detecting section 204 has detected the execution of the predetermined operation on the first object BJ1. According to another embodiment, for example, the adjusting section 205 may adjust the display location of the first object BJ1 on the display 11 after the display section 206 has displayed the second object BJ2.

What is claimed is:

1. A display control device, comprising:
a display;
a detecting section configured to detect execution of a predetermined operation on a first object displayed on the display;
an adjusting section configured to adjust a display location of the first object on the display when the detecting section has detected the execution of the predetermined operation on the first object; and
a display section configured to display a second object exhibiting information related to the first object on the display when the detecting section has detected the execution of the predetermined operation on the first object.

2. The display control device according to claim 1, further comprising:
a touch sensor, wherein
the predetermined operation refers to a touch operation on the first object.

3. The display control device according to claim 1, wherein
the first object is included in a first screen displayed on the display, and
the adjusting section adjusts the display location of the first object on the display by scrolling the first screen.

4. The display control device according to claim 1, wherein
the adjusting section adjusts the display location of the first object on the display so as to ensure an area in which the second object is displayed on the display.

5. The display control device according to claim 1, further comprising:
a first determining section configured to determine whether a user is right or left-handed, wherein
the adjusting section adjusts the display location of the first object on the display according to a determination result of the first determining section.

6. The display control device according to claim 5, wherein
the first determining section determines to display the second object to the left of the first object when the first determining section has determined the user to be right-handed, and
the first determining section determines to display the second object to the right of the first object when the first determining section has determined the user to be left-handed.

7. The display control device according to claim 5, wherein
the adjusting section adjusts the display location of the first object so that the second object is located to the left of the first object when the first determining section has determined the user to be right-handed, and
the adjusting section adjusts the display location of the first object so that the second object is located to the right of the first object when the first determining section has determined the user to be left-handed.

8. The display control device according to claim 1, further comprising:
a second determining section configured to determine whether to display the second object on one side or the other side of the display with respect to a long side direction of the display, relative to the first object, wherein
the adjusting section adjusts the display location of the first object on the display according to a determination result of the second determining section.

9. The display control device according to claim 1, further comprising:
a third determining section configured to determine whether to display the second object on one side or the other side of the display with respect to a short side direction of the display, relative to the first object, wherein
the adjusting section adjusts the display location of the first object on the display according to a determination result of the third determining section.

10. A display control method for implementation by a display control device including a display, the display control method comprising:
detecting execution of a predetermined operation on a first object displayed on the display;
adjusting a display location of the first object on the display when execution of the predetermined operation has been detected on the first object; and
displaying a second object exhibiting information related to the first object when the execution of the predetermined operation has been detected on the first object.
